(19) United States
(12) Patent Application Publication
(10) Pub. No.: US 2015/0047152 A1
(43) Pub. Date: Feb. 19, 2015

(54) HINGE ASSEMBLY

(71) Applicant: I3G DESIGN CO., LTD., New Taipei City (TW)

(72) Inventor: Yung-Fa CHENG, New Taipei City (TW)

(73) Assignee: I3G DESIGN CO., LTD., New Taipei City (TW)

(21) Appl. No.: 14/223,232

(22) Filed: Mar. 24, 2014

(30) Foreign Application Priority Data
Aug. 16, 2013 (TW) 102215466

(51) Int. Cl. F16C 11/04

(52) U.S. Cl. CPC F16C 11/04
USPC 16/354

(57) ABSTRACT

A hinge assembly of the present invention includes two parallel axle members, two gears and a transmission member. Each of the axle members has an axis and is rotatable about the axis. The gears are spaced apart from, each other, are mounted respectively and co-rotatably to the axle members, and are disposed on a plane that is perpendicular to the axis of the axle members. The transmission member is rotatable about a transmission axis that is perpendicular to and coplanar with the axes or the axle members, and meshes with the gears such that when one of the axle members rotates, the other one of the axle members is driven to rotate via the gears and the transmission member.

### CROSS-REFERENCE TO RELATED APPLICATION

This application claims priority of Taiwanese Application No. 102215466, filed on Aug. 16, 2013.

### BACKGROUND OF THE INVENTION

1. Field of the Invention

The invention relates to a hinge assembly, more particularly to a double-axis hinge assembly.

2. Description of the Related Art

A foldable electronic device generally includes two plate-shaped parts interconnected by a hinge such that the two plate-shaped parts are able to pivot relative to each other. It the foldable electronic device is a convertible tablet computer, the two plate-shaped parts may need to pivot relative to each other by nearly 360 degrees, and a double-axis hinge may consequently be employed.

Conventionally, the double-axis hinge includes two parallel axle members connected respectively to the plate-shaped parts of the foldable electronic device and mounted respectively with two gears that are meshed with each other, such that the two axle members are able to rotate simultaneously in the same rotational speed and in opposite rotational directions. Another conventional, double-axis hinge further includes two additional gears that mesh each other and that mesh respectively the two gears mounted respectively on the axle members to allow for the use of smaller gears. However, the dimensions of the conventional double-axis hinges cannot be further reduced due to geometric limitation.

### SUMMARY OF THE INVENTION

Therefore, the object of the present invention is to provide a double-axis hinge assembly having a size that is capable of being smaller than the abovementioned conventional double-axis hinges.

Accordingly, a hinge assembly of the present invention includes two parallel axle members, two gears and a transmission member. Each of the axle members has an axis and is rotatable about the axis. The gears are spaced apart from each other, are mounted respectively and co-rotatably to the axle members, and are disposed on a plane that is perpendicular to the axes of the axle members. The transmission member is rotatable about a transmission axis that is perpendicular to and coplanar with the axes of the axle members, and meshes with the gears such that when one of the axle members rotates, the other one of the axle members is driven to rotate via the gears and the transmission member.

### BRIEF DESCRIPTION OF THE DRAWINGS

Other features and advantages of the present invent ion will become apparent in the following detailed description of the preferred embodiment with reference to the accompanying drawings, of which:

FIG. 1 is a perspective view of a preferred embodiment of a hinge assembly according to the invention;

FIG. 2 is a partly exploded perspective view of the preferred embodiment;

FIG. 3 is another partly exploded perspective view of the preferred embodiment;

FIG. 4 is a side view of the preferred embodiment;

FIG. 5 is a sectional view of the preferred embodiment taken along line V-V in FIG. 4;

FIG. 6 is another side view of the preferred embodiment;

FIG. 7 is another sectional view of the preferred embodiment taken along line VII-VII in FIG. 6; and

FIGS. 8 and 9 are side views of the preferred embodiment, illustrating operation of the preferred embodiment.

### DETAILED DESCRIPTION OF THE PREFERRED EMBODIMENT

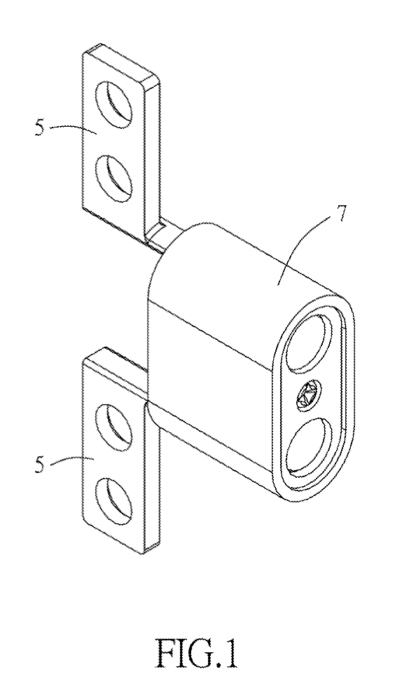

As shown in FIGS. 1 to 3 and 5, a preferred embodiment of a hinge assembly according to the present invention includes two parallel axle members 1, two gears 2, a mounting seat 3, a transmission, member 4, two brackets 5, a positioning unit 6, a casing 7 and a cap 8.

Each of the axle members 1 has an axis and is rotatable about the axis.

The gears 2 are spaced apart from each other, are mounted respectively and co-rotatably to the axle members 1, and are disposed on a plane that is perpendicular to the axes of the axle members 1. In this embodiment, each of the gears 2 is formed with a non-circular extension hole 21, and each of the axle members 1 has a non-circular cross-section and extends fittingly through the extension hole 21 of the respective one of the gears 2.

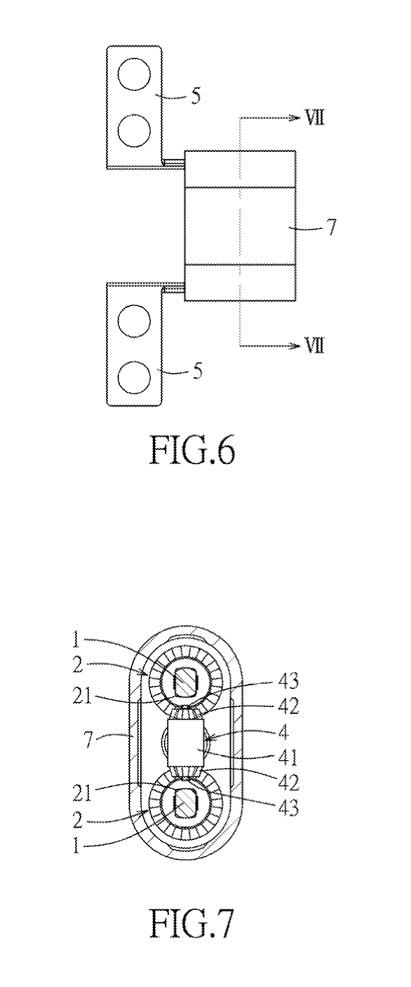

Referring further to FIGS. 6 and 7, the transmission member 4 is rotatable about a transmission axis that is perpendicular to and coplanar with the axes of the axle members 1. The transmission member 4 has a cylindrical central portion 41 that extends along the transmission axis, two gear portions 42 that are disposed respectively at opposite ends of the central portion 41 along the transmission axis, and two axle portions 43 that extend respectively from the gear portions 42 along the transmission axis.

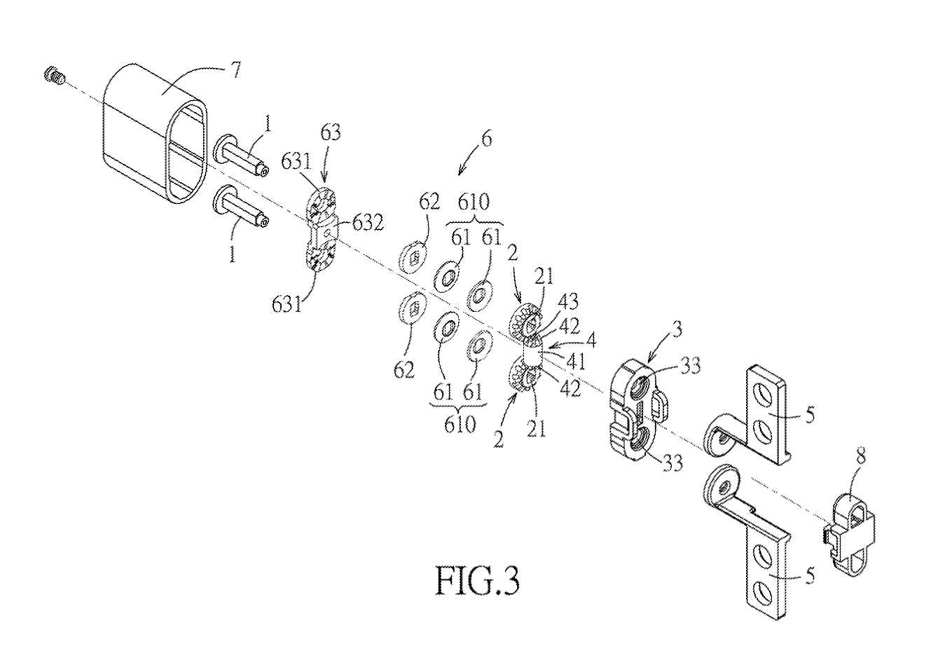

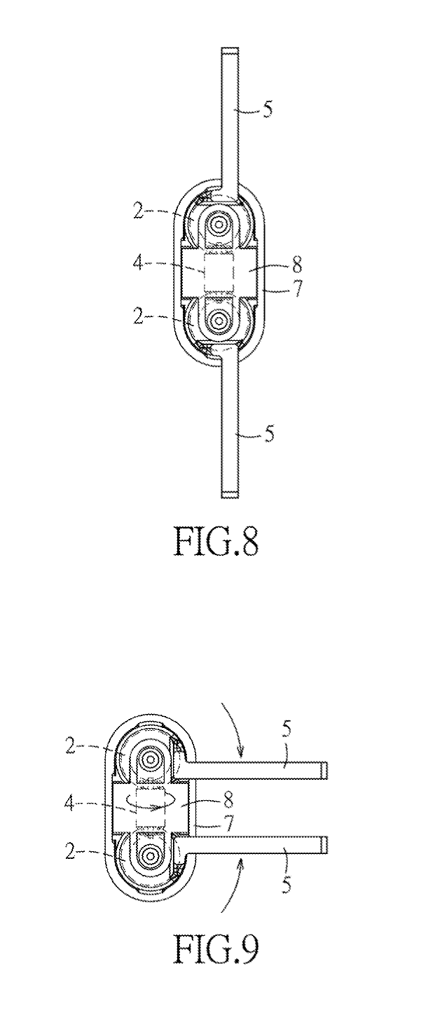

As shown in FIGS. 3 and 7, and further referring to FIGS. 8 and 9, the gear portions 42 of the transmission member 4 mesh respectively with the gears 2 such that when one of the axle members 1 rotates, the other one of the axle members 1 is driven to rotate via the gears 2 and the transmission member 4. In this embodiment, the axle members 1 are rotatable in opposite rotational directions (as indicated by the arrows in FIG. 9) and in the same rotational speed.

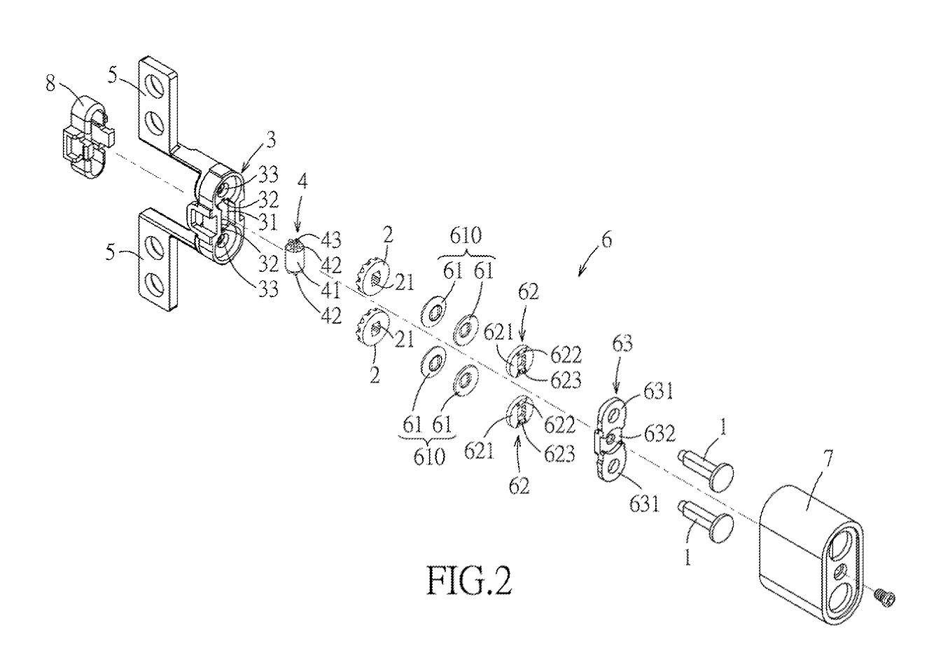

Referring back to FIG. 2, the mounting seat 3 is disposed in proximity of the gears 2, and has two support recesses 32 that are spaced apart from each other along the transmission axis and that face the gears 2, and a retaining recess 31 that faces the gears 2 and that is disposed between and communicates spatially with, the support recesses 32.

The transmission member 4 is mounted fixedly and rotatably to the mounting seat 3 with the axle portions 43 engaging respectively and rotatably the support recesses 32, and with the central portion 41 and the gear portions 42 retained partially in the retaining recess 31.

The mounting seat 3 further has two spaced-apart through holes 33. The axle members 1 extend respectively and rotatably through the through holes 33.

The brackets 5 are connected respectively and co-rotatably to the axle members 1 for being respectively connected to, for example, different parts of a foldable electronic device. Each of the brackets 5 is disposed at one side of the mounting seat 3 that is opposite to the gear 2 mounted on the respective one of the axle members 1 along the axis of the respective one of the axle members 1.

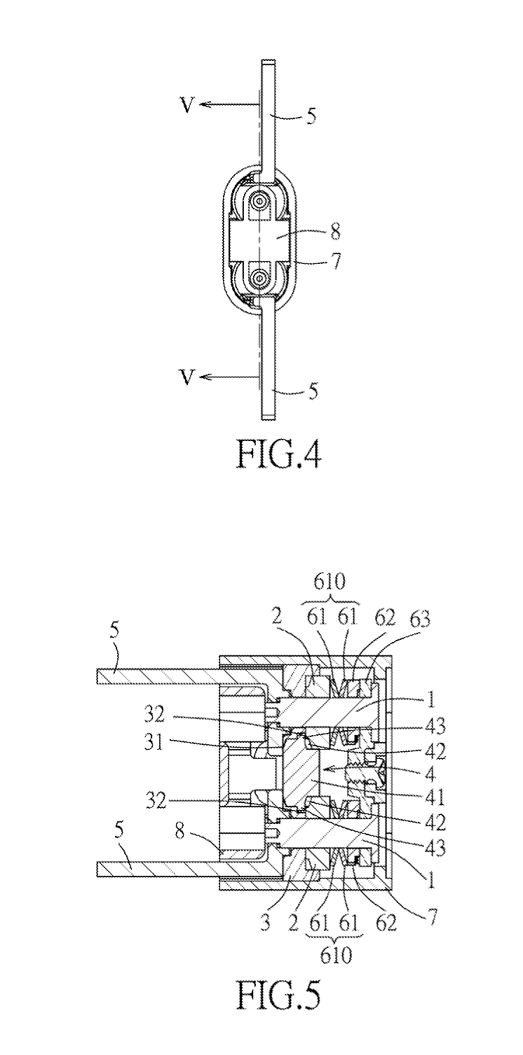

Referring to FIGS. 2 to 5, the positioning unit 6 includes two ring-shaped latch members 62, a positioning seat 63 and two resilient members 610.

The latch members 62 are mounted respectively to the axle members 1, Each of the latch members 62 is co-rotatable with and axially movable relative to the respective one of the axle members 1, and has two positioning blocks 622, 623 that protrude from a main body 621 thereof and oppositely of the gear 2 mounted on the respective one of the axle members 1. For each of the latch members 62, a distance between one of the positioning blocks 622, 623 and a center of the latch member 62 is different from that between the other one of the positioning blocks 622, 623 and the center of the latch member 62.

The positioning seat 63 is disposed at one side of the latch members 62 that is opposite to the gears 2, and has two seat segments 631 that correspond respectively in position to the latch members 62, and a connecting wail 632 that interconnects the seat segments 631. Each of the seat segments 631 is formed with a plurality of groove sets (see FIG. 3) that are angularly spaced apart from each other and that face the corresponding one of the latch members 62. Each of the groove sets has a pair of positioning grooves. The latch members 62 are operable to engage respectively the seat segments 631 with the positioning blocks 622, 623 of each, of the latch members 62 engaging one of the groove sets of the corresponding one of the seat segments 631 for positioning the axle members 1 relative to each other. In this embodiment, each of the positioning blocks 622, 623 has a fan-shaped cross-section. Each of the positioning grooves is configured to be fan-shaped. Each of the seat segments 631 is further formed with a through hole. The axle members 1 extend respectively and rot at ably through the through holes of the seat segments 631. Specifically, each of the axle members 1 extends through, the through hole of a respective one of the seat segments 631 before extending through the respective one of the through holes 33 of the mounting seat 3.

The resilient members 610 are mounted respectively to the axle members 1. Each of the resilient members 610 is configured as of a pair of conical washers 61, and is sandwiched between the gear 2 and the latch member 62 mounted on the respective one of the axle members 1 for biasing resiliently the latch member 62 toward the corresponding one of the seat segments 631.

Referring to FIGS. 2 to 4, the casing 7 and the cap 8 cooperatively define a retaining space. The axle members 1, the gears 2, the mounting seat 3, the transmission member 4 and the positioning unit 6 are disposed in the retaining space. Each of the brackets 5 has a portion that is disposed in the retaining space, and another portion that extends out of the retaining space past the cap 8.

By virtue of the engagement between the transmission member 4 and the gears 2, and the orientation of the transmission member 4 that is perpendicular to the axes of the axle members 1, the dimensions of the gears 2 can be effectively reduced, and therefore the dimensions of the hinge assembly can be reduced as well.

While the present invention has been described in connection with what is considered the most practical, and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A hinge assembly comprising:
two parallel axle members, each having an axis and being rotatable about the axis;
two spaced-apart gears mounted respectively and co-rotatably to said axle members, and being disposed on a plane that is perpendicular to the axes of said axle members; and
a transmission member rotatable about a transmission axis that is perpendicular to and that is coplanar with the axes of said axle members, and meshing with said gears such that when one of said axle members rotates, the other one of said axle members is driven to rotate via said gears and said transmission member.

2. The hinge assembly as claimed in claim 1, wherein said axle members are rotatable in opposite rotational directions and in the same rotational speed.

3. The hinge assembly as claimed in claim 1, further comprising amounting seat that is disposed in proximity of said gears, said transmission member being mounted fixedly and rotatably to said mounting seat, each of said gears being formed with a non-circular extension hole, each of said axle members having a non-circular cross-section and extending fittingly through said extension hole of the respective one of said gears.

4. The hinge assembly as clamed in claim 3, wherein:
said mounting seat has two support recesses spaced apart from each other along the transmission axis and facing said gears; and
said transmission member has two spaced-apart axle portions extending along the transmission axis and engaging respectively and rotatably said support recesses.

5. The hinge assembly as claimed in claim 4, wherein said transmission member further has
a cylindrical central portion that extends along the transmission axis, and
two gear portions that are disposed respectively at opposite ends of said central portion along the transmission axis, and that mesh respectively with said gears, said axle portions extending respectively from said gear portions.

6. The hinge assembly as claimed in claim 5, wherein said mounting seat further has a retaining recess that faces said gears, and that is disposed between and communicates spatially with said support recesses, said central portion and said gear portions of said transmission member being retained partially in said retaining recess.

7. The hinge assembly as claimed in claim 3, wherein said mounting seat has two spaced-apart through holes, said axle members extending respectively and rotatably through said through holes.

8. The hinge assembly as claimed in claim 7, further comprising two brackets that are connected respectively and co-rotatably to said axle members, each of said brackets being disposed at one side of said mounting seat that is opposite to said gear mounted on the respective one of said axle members along the axis of the respective one of said axle members.

9. The hinge assembly as claimed in claim 3, further comprising a positioning unit that includes
two ring-shaped latch members mounted respectively to said axle members, each of said latch members being co-rotatable with and axially movable relative to the respective one of said axle members, and having two positioning blocks that protrude oppositely of said gear mounted on the respective one of said axle members, wherein for each of said latch members, a distance between one of said positioning blocks and a center of said latch member is different from that between the other one of said positioning blocks and the center of said latch member,
a positioning seat disposed at one side of said latch members that is opposite to said gears, and having two seat segments that correspond respectively in position to said latch members, and a connecting wail that interconnects said seat segments, each of said seat segments being formed with a plurality of groove sets that are angularly spaced apart from each other and that face the corresponding one of said latch members, each of said groove sets having a pair of positioning grooves, said latch members being operable to engage respectively said seat segments with said positioning blocks of each of said latch members engaging one of said groove sets of the corresponding one of said seat segments for positioning said axle members relative to each other; and
two resilient members mounted respectively to said axle members, each of said resilient members being configured as a pair of conical washers, and being sandwiched between said gear and said latch member-mounted on the respective one of said axle members for biasing resiliently said latch member toward the corresponding one of said seat segments.

10. The hinge assembly as claimed in claim 9, wherein each of said positioning blocks has a fan-shaped cross-section, and each of said positioning grooves is configured to be fan-shaped.

11. The hinge assembly as claimed in claim 9, further comprising:
two brackets that are connected respectively and co-rotatably to said axle members, each of said brackets being disposed at one side of said mounting seat that is opposite to said gear mounted on the respective one of said axle members along the axis of the respective one of said axle members;
a casing; and
a cap cooperating with said casing to define a retaining space, said axle members, said gears, said mounting seat, said transmission member and said positioning unit being disposed in said retaining space, each of said brackets having a portion that is disposed in said retaining space, and another portion that extends out of said retaining space past said cap.
